(19) United States
(12) Patent Application Publication
(10) Pub. No.: US 2024/0020812 A1
(43) Pub. Date: Jan. 18, 2024

(54) METHOD FOR DETERMINING A STATE OF AT LEAST ONE FLOOR ELEMENT, ASSOCIATED SYSTEM AND ASSEMBLY

(71) Applicants: wiiDetect, TOULOUSE (FR); ORAK, Villebon-sur-Yvette (FR)

(72) Inventors: Nicolas Eric Marie LOHEAC, RUEIL MALMAISON (FR); Francis BECKERS, BUSSY SAINT GEORGES (FR); Xavier Maurice Germain ROMERO, SAINT-OUEN-L'AUMÔNE (FR); Carole Sophie TEURIO, MILLERY (FR); Martin DEUDON, TOULOUSE (FR); Yassine ECH-CHEBLAOUY, TOULOUSE (FR)

(21) Appl. No.: 18/351,371

(22) Filed: Jul. 12, 2023

(30) Foreign Application Priority Data
Jul. 13, 2022 (FR) 22 07233

(51) Int. Cl. G06T 7/00; G01D 21/00; G06V 10/82; G06V 10/764

(52) U.S. Cl. CPC G06T 7/0002; G01D 21/00; G06V 10/82; G06V 10/764; G06T 2207/10024; G06T 2207/20084; G06T 2207/20081

(57) ABSTRACT

Disclosed is a method for determining a state, in particular a state of wear, of at least one floor element, the determination method including: —a step of receiving signals from measurement of the floor element coming from at least two sensors of different types; —a step of determining a characteristic of the floor element with regard to the state thereof by use of at least one neural network according to the measurement signals.

### CROSS-REFERENCE TO RELATED APPLICATIONS

This application claims priority to FR Patent Application No. 22 07233 filed Jul. 13, 2022, the entire contents of which are hereby incorporated by reference.

### BACKGROUND OF THE INVENTION

### Field of the Invention

The present invention relates to a method for determining a state of at least one floor element.

The invention also relates to a system for determining a state of at least one floor element.

The invention also relates to an assembly comprising such a determination system and a measurement system.

The present invention relates to the field of control of floor elements aiming at reusing such elements.

### Description of the Related Art

In order to reduce the environmental impact and costs, some users decide to clean floor elements, such as carpet tiles or have same cleaned, after a period of use, aiming at a new use for the carpet tiles.

However, some of the tiles are worn out in such a way that a reuse is not possible. In order to decide whether a reuse of a given carpet tile is possible, an operator usually checks the state of each tile manually, in particular by visual inspection.

Such inspection is based in particular on the experience of the operator and is thus likely to vary. Many factors can alter the decision of the operator, even an experienced operator, e.g. inspection circumstances such as brightness.

Also, a subjective perception can influence the inspection, such as e.g. the wear of a previously controlled tile.

Manual inspection of a large number of tiles can also take a long time, since each tile must be inspected individually.

Finally, some types of wear are difficult to detect, or are even non-detectable by visual inspection by the operator.

A goal of the invention is then to at least reduce the aforementioned drawbacks.

More particularly, a goal of the invention is to obtain a method for determining a state of at least one floor element, which is particularly reliable and/or rapid.

### SUMMARY OF THE INVENTION

To this end, a subject matter of the invention is a method for determining a state, in particular a state of wear, of at least one floor element, the determination method comprising:
a step of receiving signals from measurement of the floor element coming from at least two sensors of different types;
a step of determining a characteristic of the floor element with regard to the state thereof by means of at least one neural network according to the measurement signals.

The determination method determines a state of at least one floor element. The method is particularly reliable, since said neural network allows the characteristics of the floor element with regard to the state thereof to be determined in an automated and particularly reliable manner.

Also, the use of at least two sensors of different types increases reliability, since different properties of the floor element are thus taken into account for the state-related characteristic.

Moreover, the determination method is particularly reliable, since the measurement signals are used for measuring wear data which are difficult to detect, or are even non-detectable, by e.g. visual inspection by an operator.

The determination method is particularly fast, because the state-related characteristic is determined very quickly by the neural network, following the reception of the measurement signals.

According to other advantageous aspects of the invention, the determination method comprises one or a plurality of the following characteristics, taken individually or according to all technically possible combinations:
the type of each sensor is selected from the list consisting of an image sensor configured for taking at least one image in a predetermined color space, such as the RGB color space or the HSL color space; an image sensor such as an ultraviolet sensor; an image sensor such as an infrared sensor; an image sensor such as a depth sensor; an image sensor such an ultrasound sensor, and a hydrometry sensor;
the determination step is implemented by a first neural network and by a second neural network receiving as input at least one output datum from the first neural network;
the determination step comprises a detection sub-step, implemented by the first neural network, during which the first neural network outputs either an indication according to which floor element shows wear less than or equal to a wear threshold, or an indication that the floor component shows wear above the wear threshold;
the first neural network is a neural network previously trained by a floor element forming a model so as to define the wear threshold;
the determination step further comprises a sub-step of classification of a defect of the floor element, implemented by the second neural network, during which the second neural network outputs said characteristic of the floor element, comprising a defect class of said floor element dependent on the measurement signals;
when the output indication of the first neural network indicates that the floor element shows a wear greater than the wear threshold, the first neural network also outputs at least one position on one face of the floor element, of said defect of the floor element;
at least one of the measurement signals comprises at least one image of the floor element, the determination step comprising a pre-processing sub-step, during which the image of the floor element is cut into a plurality of parts of identical sizes;
during the detection sub-step, the first neural network receives as input, at least each part of the image of the floor element, and outputs at least the corresponding indication for each part of the image of the floor element;
at least one signal of the measurement signals comprises a hydrometry measurement of the floor element, and the determination step further comprises a hydrometry analysis sub-step, during which a hydrometry analysis module generates an alert when the hydrometry measurement of the floor element comprises a level of moisture strictly below a predetermined lower threshold or strictly above a predetermined upper threshold;
the method further comprises a step of measuring the floor element in order to obtain the measurement signals, the measurement step comprising at least a first and a second successive measurement, the floor element being illuminated by a movable lighting device, the first measurement being obtained when the movable lighting device is positioned at a first position with respect to the floor element, and the second measurement being obtained when the lighting device is positioned at a second position different from the first position;
the method further comprises a step of transmitting at least the characteristic of the floor element with respect to state thereof to at least one determination system remote from a determination system implementing the determination method, for a learning of a neural network remote from the remote determination system.

A further subject matter of the invention is a system for determining a state, in particular a state of wear, of at least one floor element, the determination system comprising a receiver module configured for receiving measurement signals from the floor element from at least two sensors of different types. The determination system is configured for determining a characteristic of the floor element with respect to the state thereof by at least one neural network according to the measurement signals.

A further subject matter of the invention is an assembly comprising a determination system as described above, and further comprising a measurement system comprising a device for transporting the at least one floor element, and at least two sensors of different types.

### BRIEF DESCRIPTION OF THE DRAWINGS

The characteristics and advantages of the invention will appear upon reading the following description, given only as an example, but not limited to, and making reference to the enclosed drawings, wherein:

FIG. 1 is a schematic view of an assembly comprising a measurement system and a determination system according to the invention;

FIG. 2 is a schematic view of a network of a plurality of assemblies shown in FIG. 1, connected therebetween, and

FIG. 3 is a flowchart of a method for determining a state of at least one floor element according to the invention, implemented by the assembly shown in FIG. 1.

### DETAILED DESCRIPTION

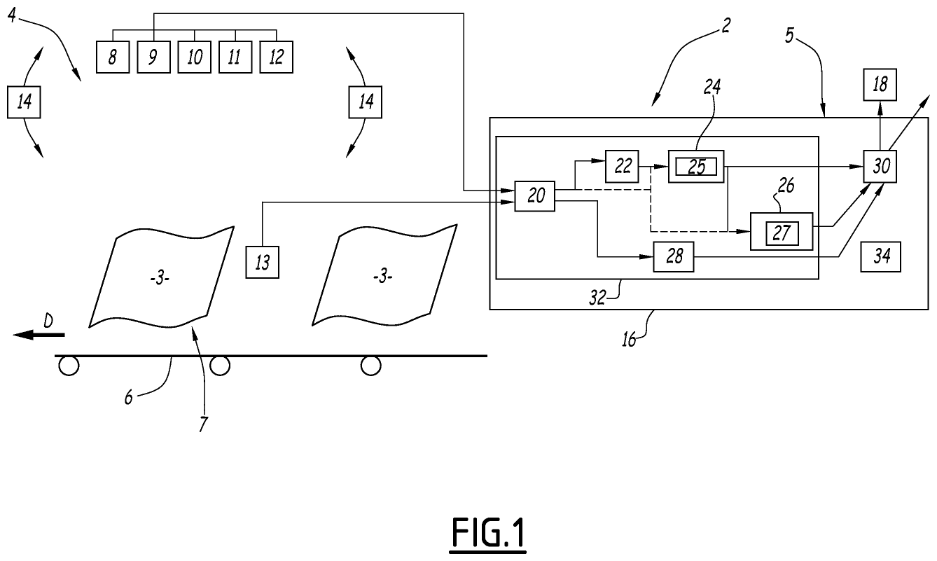

With reference to FIG. 1, an assembly 2 is configured for determining a state of at least one floor element 3, in particular a state of wear of the floor element 3.

In FIG. 1, two floor elements 3 are shown. Each floor element 3 is e.g. a carpet tile. More particularly, each floor element 3 comprises at least one face comprising textile parts.

Each floor element 3 preferentially has predetermined dimensions. For example, each floor element 3 is quadratic. According to one example, each floor element 3 has a length and a width which are each substantially equal to 50 cm.

According to another example, each floor element 3 is rectangular. For example, each floor element 3 has a length equal to 25 cm and a width equal to 100 cm.

The assembly 2 comprises a measurement system 4 and a determination system 5 for the state of the floor element 3.

The measurement system 4 comprises e.g. a transport device 6 configured for transporting the floor element 3 to a measurement position 7, sensors 8, 9, 10, 11, 12, 13 configured for obtaining measurements of the floor element 3 positioned at the measurement position 7, and at least one movable lighting device 14.

The measurement system 4 comprises at least two sensors 8, 9, 10, 11, 12, 13 of different types. Preferentially, the measurement system 4 comprises more than two sensors of different types. Also preferentially, the measurement system 4 comprises each of the types of sensors 8, 9, 10, 11, 12, 13. Examples of such sensors are described hereinbelow.

By “type” or “sensor type” means a sensor measurement technology for measuring or detecting a property of the floor element 3.

The measurement system 4 further comprises e.g. a box (not shown) forming a space comprising the measurement position 7, and wherein the sensors 8 to 13 are arranged. The space formed by the box is in particular impervious to light from the outside of the box. For example, interior surfaces are painted in a black color apt to absorb at least certain rays of light.

The transport device 6 comprises e.g. a conveyor belt configured for moving each floor element 3 along a transport direction D. For example, the conveyor belt is configured for moving the floor elements 3 one after the other along the conveying direction D, to the measurement position 7 for a measurement by the sensors 8, 9, 10, 11, 12, 13. For example the conveyor belt is configured for stopping for a predetermined period of time when one of the floor elements 3 is positioned at the measurement position 7, and then transporting the next floor element 3 to the measurement position 7.

Each of the sensors 8, 9, 10, 11, 12, 13 is preferentially of a different type from each other.

For example, the type of each sensor 8 to 13 is chosen from the following types of sensors: an image sensor 8 configured for taking at least one image in a predetermined color space; an image sensor such as an ultraviolet sensor 9; an image sensor such as an infrared sensor 10; an image sensor such as a depth sensor 11; an image sensor such an ultrasound sensor 12, and a hydrometry sensor 13.

The image sensor 8 is configured e.g. for to taking at least one color image in the RGB (Red Green Blue) color space. According to another example, the image sensor 8 is configured for taking at least one image in the HSL (Hue, Saturation, Lightness) color space.

Preferentially, the measurement system 4 comprises two image sensors 8, one configured for taking at least one in the RBG color space, and the other configured for taking the image in the HSL color space.

The ultraviolet image sensor 9 is configured for taking at least one image from ultraviolet rays.

The infrared image sensor 10 is configured for taking at least one image from infrared rays.

Each image sensor 8, 9 and 10 can be used in particular for obtaining measurements relating to defects in the color or texture of the floor element 3.

The depth image sensor 11 is configured for taking at least one image comprising the depth, or distance, of a face of the floor element 3 with respect to the depth sensor 11. More particularly, the depth sensor 11 is configured for measuring the flight time of signals transmitted towards the floor element 3 and received by reflection of the signals by the floor element 3.

The depth sensor 11 is used more particularly for obtaining measurements relating to a texture and/or a relief of the floor element 3.

The ultrasound image sensor 12 is configured for taking at least one image of the floor element 3 using ultrasounds. The ultrasound sensor 12 used more particularly for obtaining measurements relating to foreign bodies inside the floor element 3, such as dust.

The hydrometry sensor 13 is configured for measuring the moisture of the floor element 3. The hydrometry sensor 13 comprises e.g. at least two spikes apt to be in contact with the floor element 3 during the measurement of moisture.

In the example shown in FIG. 1, the measurement system 3 comprises two movable lighting devices 14.

Each movable lighting device 14 is movable with respect to the floor element 3 and/or with respect to the measurement position 7. More particularly, each movable lighting device 14 is provided with means of positioning (not shown), configured for positioning the device 14 with respect to the measurement position 7. According to one example, the means of positioning comprise rails having a helix shape.

The determination device 5 is configured for determining the state of the floor element 3.

According to the invention, the determination device 5 is configured for determining a characteristic of the floor element 3 with regard to the state thereof, in particular the state of wear thereof.

The determination device 5 comprises e.g. a computer 16 and a display device 18 configured for displaying data or information received from the computer 16.

The computer 16 comprises e.g. a reception module 20, a preprocessing module 22, a detection module 24 comprising a first neural network 25, a classification module 26 comprising a second neural network 27, a hydrometry analysis module 28 and a transmission module 30.

Each neural network 25 and 27 is an artificial neural network preferentially comprising a plurality of layers. The first neural network 25 comprises e.g. at least 500 hidden layers.

In the example shown in FIG. 1, the receiver module 20, the preprocessing module 22, the detection module 24, the classification module 26, the hydrometry analysis module 28, and the transmission module 30 are each produced, at least in part, in the form of a software program, or of a software brick, e.g. stored in a memory 32 of the calculator 16 and which can be executed by a processor 34 of the calculator 16.

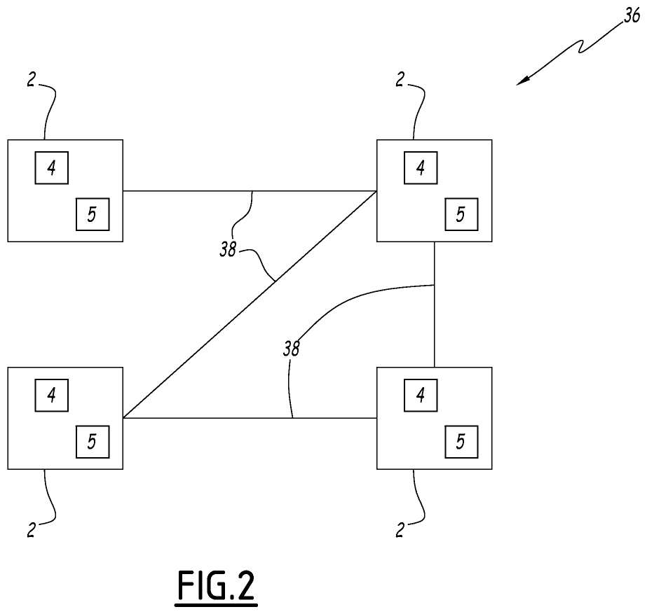

With reference to FIG. 2, a network 36 comprises a plurality of assemblies 2, preferentially identical to each other, each comprising the measurement system 4 and the determination system 5 for the state of the floor element 3. The assemblies 2 are apt to communicate with one another via data links 38. More particularly, the assemblies 2 are configured for exchanging the characteristics relating to the state of a respective floor element 3, determined by the respective determination systems 5, in particular aimed at a learning from the first and/or second neural network 25, 27 of each determination system 5.

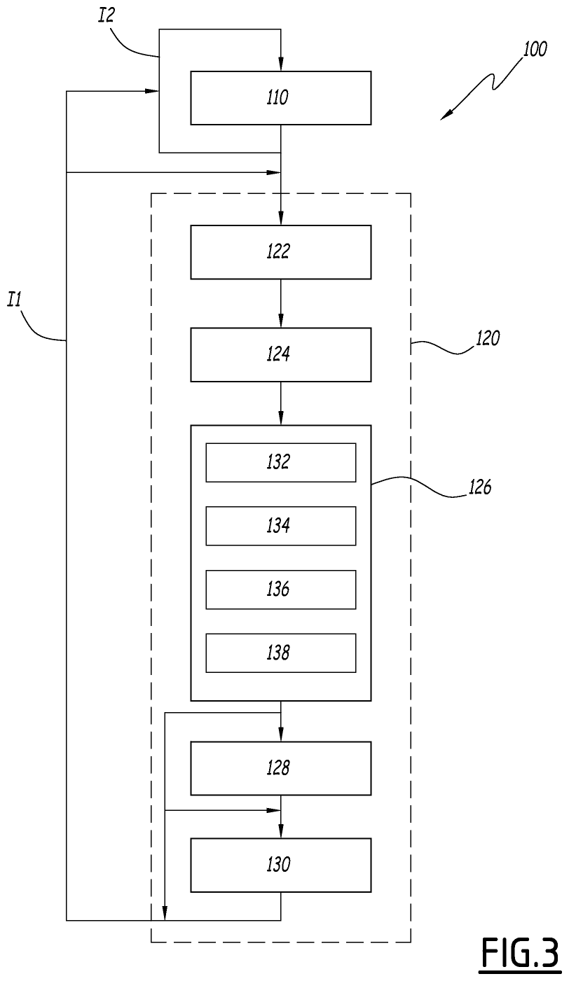

The operation of the assembly 2 and more particularly of the determination system 5 will now be described with reference to FIG. 3 which is a flowchart of a determination 100 of the state, in particular of the state of wear, of the floor element 3.

The determination method 100 comprises in particular a learning phase 110 and an operation phase 120.

During the learning phase 110, the first neural network 25 is trained.

For example, the first neural network 25 receives at the input thereof, measurement signals, in particular from the sensors 8 to 13, from a floor element 3 which forms a model. “The floor element 3 forming a model” refers to a floor element with no defects, more particularly a floor element which is not worn or is not very worn.

Preferentially, a wear threshold is defined during the learning phase 110 by training the first neural network 25.

The wear threshold is an indication whether a wear of the floor element 3 is acceptable or not e.g. by a user, in particular in view of a re-use.

The wear threshold is obtained in particular by training the first neural network 25 with the floor element 3 forming a model.

According to one example, during the learning phase 110, the second neural network 27 is also trained. More particularly, the second neural network 27 receives at the input thereof, an output of the first neural network 25. As an optional addition, the second neural network 27 receives the measurement signals as input.

Preferentially, the training of the first and/or second neural network 25, 27 is unsupervised training.

The learning phase 110 is preferentially implemented at least once before the implementation of the operation phase 120.

According to one embodiment, the learning phase 110 and the operation phase 120 are executed simultaneously.

The operation phase 120 comprises e.g. a measurement step 122, a reception step 124, a determination step 126, a transmission step 128 and a display step 130.

During the measurement step 122, the measurement system 4 measures the floor element 3 and generates the measurement signals. More particularly, each sensor 8 to 13 generates at least one measurement signal of the plurality of measurement signals.

For example, the image sensor 8 generates a measurement signal comprising at least one image of the floor element 3 in the predetermined color space.

The ultraviolet sensor 9 generates a measurement signal comprising at least one image of the floor element 3 obtained from ultraviolet rays, and the infrared sensor 10 generates a measurement signal comprising at least one image of the floor element 3 obtained from infrared rays.

The depth sensor 11 generates more particularly a measurement signal comprising at least one image comprising the depth, or distance, from the face of the floor element 3 facing the sensor 11.

The ultrasound sensor 12 generates more particularly a measurement signal comprising an image of the floor element 3 obtained from the ultrasound [waves].

The hydrometry sensor 13 generates more particularly a measurement signal comprising the moisture content of at least part of the floor element 3.

Preferentially, during the measurement step 122, the movable lighting device 14 illuminates the floor element 3 which is positioned at the measurement position 7 during the measurement step 122.

According to one example, the measurement step 122 comprises at least a first measurement and a second measurement, successively. For example, the first measurement is obtained when the movable lighting device 14 is positioned at a first position with respect to the floor element 3, and the second measurement is obtained when the lighting device 14 is positioned at a second position different from the first position.

The first and second positions are in particular three-dimensional positions, arranged more particularly inside the box (not shown) of the measurement system 4.

The different positions during the first and second measurement are used in particular for detecting different defects of the floor element 3.

According to one example, the measurement step 122 comprises measurements at more than two different positions of the movable lighting device 14, e.g. at 4 or 5 different positions. During the reception step 124, the reception module 20 receives the measurement signals from the floor element 3 coming from the sensors 8 to 13.

During the determination step 126, the determination system 5 determines the characteristic of the floor element 3 relating to the state thereof, in particular the state of wear thereof. To this end, the floor element 3 is more particularly positioned in the measurement position 7.

The determination step 126 is preferentially implemented by the first neural network 25 and by the second neural network 27.

Preferentially, in the example illustrated in FIG. 1, the second neural network 27 receives at the input thereof, at least one output datum from the first neural network 25.

The determination step 126 comprises e.g. a hydrometry analysis sub-step 132, a preprocessing sub-step 134, a detection sub-step 136 and a classification sub-step 138.

During the hydrometry analysis sub-step 132, the hydrometry analysis module 28 analyzes the measurement signal received from the hydrometry sensor 13. The hydrometry analysis module 28 generates an alert when the measurement signal comprising the moisture of the floor element 3 comprises a moisture strictly lower than a predetermined lower threshold or strictly higher than a predetermined upper threshold.

According to one example, the hydrometry analysis module 28 sends at least one signal comprising a moisture value of the floor element 3 to the emission module 30. When the moisture value is not between the predetermined lower threshold and the predetermined upper threshold, this signal preferentially comprises the alert.

According to one example, when the signal emitted by the hydrometry analysis module 28 comprises the alert, the sub-steps 134, 136, 138 are not implemented. More particularly, in such case, the measured floor element 3 is unsuitable for re-use, and an analysis of other properties of the floor element 3 is thereby unnecessary.

During the preprocessing sub-step 134, the preprocessing module 22 receives at least one of the measurement signals which comprises at least one image of the floor element 3, e.g. obtained by one of the sensors 8 to 12.

The preprocessing module 22 divides the image into a plurality of parts of identical sizes and sends each part of the image to the detection module 24 for the implementation of the detection sub-step 136.

For example, during the preprocessing sub-step 134, the preprocessing module 22 cuts the image into a predetermined number, preferentially equal to a power of two, such as 4, 8, 16, 32,

According to one example, the preprocessing module 22 transmits each part of the image separately to the detection module 24 for the implementation of the sub-step 136 for each part of the image.

According to another example, the preprocessing module 22 generates an image from the cut-out parts, by assembling the parts according to a predetermined order or according to a random order and sends the generated image to the detection module 24 for the implementation of the sub-step 136.

For example, the preprocessing module 22 divides up the image so as to obtain a plurality of series of image parts. Each series of images preferentially includes images of the same size. Preferentially yet, each series comprises a different number of images with respect to the other series of images, in particular equal to a power of two.

For example, a first series of image parts consists of 4 images, a second series of image parts comprises 8 images, and so on.

The preprocessing module assembles the parts of each series of images so as to obtain one or a plurality of images generated from each series of images and sends each generated image to the detection module 24 for the implementation of the sub-step 136.

During the detection sub-step 136, the detection module 24 receives the image or images from the preprocessing module 22.

In a variant or in addition, the detection module 24 receives one or a plurality of the measurement signals, in particular from the reception module 20. The above is illustrated in FIG. 1 by a broken line between the module 20 and the module 24.

More particularly, the first neural network 25 receives as input each part of the image of the floor element 3 and/or the measurement signals comprising the images of the floor element 3.

Preferentially, the first neural network 25 receives as input at the same time, each image of the floor element 3, separately each image part cut by the preprocessing module 22, and each image generated from the image parts.

The first neural network 25 preferentially outputs either an indication that the floor element 3 shows wear less than or equal to the wear threshold, or an indication that the floor element 3 shows wear greater than the wear threshold.

Preferentially, the wear threshold is defined during the learning phase 110, more particularly prior to the implementation of the operation phase 120.

When the first neural network 25 receives as input the cut-out parts of the image of the floor element 3 separately, the neural network 25 supplies the corresponding indication with respect to the wear threshold for each part of the image of the floor element 3.

When the first neural network 25 receives as input at the same time, each image of the floor element 3, separately each image part, and each image generated from the image parts, the neural network 25 preferentially outputs the indication for each of the inputs.

According to a preferred example, when the output indication of the first neural network 25 indicates that the floor element shows a wear greater than the wear threshold, the first neural network 25 furthermore outputs at least one position, on one face of the floor element of at least one defect in the floor element 3. As an optional addition, the first neural network 25 further outputs a size, a degree and/or a type of defect.

During the classification sub-step 138, the classification module 26 classifies the defect(s) of the floor element 3.

The second neural network 27 receives at the input thereof at least one output of the first neural network 25, in particular the indication whether the floor element 3 shows a wear less than, equal to or greater than the wear threshold.

As an optional addition, the second neural network 27 receives as input the position of the defect of the floor element 3 on the face of the floor element 3, the size, the degree and/or the type of the defect, in particular from the first neural network 25.

As an optional addition, the second neural network 27 receives the measurement signals as input.

The second neural network 27 outputs the characteristic of the floor element 3 with respect to the state of wear thereof.

The characteristic preferentially comprises a defect class of the floor element 3 dependent on the measurement signals.

The defect class is preferentially defined by the second neural network 27 as a result of learning. More particularly, the second neural network 27 implements the classification sub-step 138 for a plurality of different floor elements 3 and defines classes more particularly from output data of the first neural network 25 and/or of the output signals.

For example, the defect class is a stain on the floor element 3, a hole and/or at least partial destruction, such as abrasion, of a textile part of the floor element 3.

During the transmission step 128, the transmission module 30 transmits the characteristic relating to the state of the floor element 3.

According to one example, the transmission module 30 transmits the characteristic to the display device 18. As an optional addition, the transmission module 30 further transmits the indication obtained at the output of the first neural network 25 and/or one or a plurality of the measurement signals.

According to another example, or in addition, the transmission module 30 transmits the characteristic of the floor element 3 to a remote determination system with respect to the determination system 5 implementing the determination method 100, for training a neural network remote from the remote determination system. For example, with reference to FIG. 2, the transmission module 30 transmits the characteristic to another assembly 2 of the network 36. As an optional addition, the transmission module 30 further transmits the indication obtained at the output of the first neural network 25 and/or one or a plurality of the measurement signals to the remote determination system.

During the display step 130, the display device 18 displays the characteristic relating to the state of the floor element 3, the indication obtained at the output of the first neural network 25 and/or one or a plurality of the measurement signals.

The determination method 100, in particular the operation phase 120, is preferentially repeated a plurality of times for different floor elements 3, defining successive iterations. The above is illustrated e.g. in FIG. 3 by arrows 11 for the operation phase 120.

Preferentially, during the operation phase 120, each neural network 25, 27 is trained by the preceding iteration(s).

The learning phase 110 is preferentially repeated a plurality of times, as illustrated by the arrow 12.

The measurement step 122 is an optional step. In a variant, the measurement signals are obtained from a database (not shown).

The display step 130 and/or the transmission step 128 are optional steps.

1. A method for determining a state of at least one floor element, the determination method comprising:
a step of receiving signals from measurement of the floor element coming from at least two sensors of different types;
a step of determining a characteristic of the floor element with regard to the state thereof by means of at least one neural network depending on the measurement signals.

2. The determination method according to claim 1, wherein the state of at least one floor element is a state of wear.

3. The determination method according to claim 1, wherein the type of each sensor is selected from the list consisting of:
an image sensor configured for taking at least one image in a predetermined color space;
an ultraviolet image sensor;
an infrared image sensor;
a depth image sensor;
an ultrasonic image sensor, and
a hydrometry sensor.

4. The determination method according to claim 3, wherein the predetermined color space is the RGB color space.

5. The determination method according to claim 3, wherein the predetermined color space is the HSL color space.

6. The determination method according to claim 1, wherein the determination step is implemented by a first neural network and by a second neural network receiving as input at least one output datum from the first neural network.

7. The determination method according to claim 6, wherein the determination step comprises a detection sub-step implemented by the first neural network, during which the first neural network outputs either an indication that the floor element shows a wear less than or equal to a wear threshold, or an indication that the floor element shows a wear greater than the wear threshold,
the first neural network being a neural network previously trained by a floor element forming a model, so as to define the wear threshold.

8. The determination method according to claim 6, wherein the determination step further comprises a sub-step of classifying a defect in the floor element, implemented by the second neural network, during which the second neural network outputs said characteristic of the floor element, comprising a defect class of said floor element dependent on the measurement signals.

9. The determination method according to claim 8, taken in combination with claim 4, wherein, when the output indication from the first neural network indicates that the floor element shows a wear greater than the wear threshold, the first neural network further outputs at least one position, on a face of the floor element, of said defect of the floor element.

10. The determination method according to claim 6, wherein at least one signal of the measurement signals comprises at least one image of the floor element, the determination step comprising a preprocessing sub-step, during which the image of the floor element is divided into a plurality of parts of identical sizes.

11. The determination method according to claim 10, wherein during the detection sub-step, the first neural network receives as input, at least each part of the image of the floor element, and outputs at least the corresponding indication for each part of the image of the floor element.

12. The determination method according to claim 1, wherein at least one of the measurement signals comprises a hydrometry measurement of the floor element, and the determining step further comprises a hydrometry analysis sub-step, during which a hydrometry analysis module generates an alert when the hydrometry measurement of the floor element comprises a moisture strictly lower than a predetermined lower threshold or strictly higher than a predetermined upper threshold.

13. The determination method of according to claim 1, further comprising a step of measuring the floor element in order to obtain the measurement signals, the step of measuring comprising at least a first and a second successive measurement, the floor element being illuminated by a movable lighting device, the first measurement being obtained when the movable lighting device is positioned at a first position with respect to the floor element, and the second measurement is obtained when the lighting device is positioned at a second position different from the first position.

14. The determination method according to claim 1, further comprising a step of transmitting at least the characteristic of the floor element with respect to the state thereof to at least one determination system remote from a determination system implementing the determination method, for training a neural network remote from the remote determination system.

15. A system for determining a state of at least one floor element, the system comprising a receiver module configured for receiving signals from measurement of the floor element coming from at least two sensors of different types,
the determination system being configured for determining a characteristic of the floor element with respect to the state thereof by at least one neural network depending on the measurement signals.

16. The system according to claim 15, wherein the state of at least one floor element is a state of wear.

17. An assembly comprising a determination system according to claim 15, and further comprising a measurement system comprising a transport device for the at least one floor element, and at least two sensors of different types.
